(19) United States
(12) Patent Application Publication
(10) Pub. No.: US 2018/0167505 A1
(43) Pub. Date: Jun. 14, 2018

(54) SYSTEM FOR REAL TIME DIALING ANALYSIS

(71) Applicant: TCN Incorporated, St. George, UT (US)

(72) Inventors: Jesse Bird, Saint George, UT (US); Florin Stan, Saint George, UT (US)

(21) Appl. No.: 15/374,953

(22) Filed: Dec. 9, 2016

(51) Int. Cl. H04M 3/51; H04M 3/22

(52) U.S. Cl. CPC H04M 3/5175; H04M 2203/401; H04M 3/22

(57) ABSTRACT

A system and method for providing quality calls and predictive and real-time dialing analysis. The system may provide easy calling for an agent and simple feedback for a client. An agent is provided a number to call from a system with parameters previously setup by the client. An agent may make a call, automatically through the system, to a customer and recite a script provided to the agent. The agent may garner responses from the customer and provide information to the system, via a questionnaire or other means, based on the customer feedback. The system may record and transcribe the phone call and simultaneously mark and tag the script and transcription and provide immediate feedback to the system, the supervisor and the agent allowing for more accurate call analysis and predictive analysis of future calls based on the real-time feedback garnered by the agent and entered into the system.

### TECHNICAL FIELD

This disclosure relates generally to predicting and real time analysis of phone calls and more specifically, to methods and systems and computer readable media for system automation in making calls and call flow for businesses and call centers.

### BACKGROUND OF RELATED ART

Call centers have long been utilized by businesses to obtain feedback from current customers, potential customers or former customers. Call centers with predictive dialers have been utilized for telemarketing, surveys, collections and many other uses in the business industry. Predictive dialing has been around for many years. Machines that would call up random phone numbers have been utilized for decades and in comes cases have been called robodialers. These machines were often utilized by telemarketers to determine if the caller received busy signals, no answer or voicemail.

More advanced predictive dialing can associate phone numbers with individuals and based on past customer reception, that information is input into a system so that the number is attached with positive or negative feedback. Furthermore, predictive dialers can provide a prediction of calling agent productivity. Predictive dialers can provide past feedback to allow for future projections and goals for calling agents. Predictive dialers may also aid in maximizing the productivity of a calling agent. Based on past performance, new predictions are made and typically algorithms are utilized to control a ratio of calls to agents. As regulations increase some types of predictive dialing are less effective (such as random number or sequential number dialing).

Sadly, the predictive dialers currently utilized only have the tendency to predict based on past calls or a history of calls. Furthermore, because these are history based it is unlikely to be a true and accurate prediction because it only associates previous call history to projected call success. Most predictive dialers work via simulations. The following disclosure is a method for making dialers more effective based on the actual list that is being dialed by constantly reviewing the most recent calls, responses, results, and agent state and making adjustments.

### SUMMARY

Disclosed herein is a system and method that will remedy many of the deficiencies of current predictive dialing systems. For example, the current system will allow for real time analysis of calls and may not rely solely on a previous batch of history of calls. Rather, the entire history may be analyzed against the call that is currently being made by the agent and real time analysis and feedback provided to the agent and his/her supervisor(s) as well as the system itself.

As regulations and controls and requirements proliferate making each contact more valuable and more important it becomes mandatory that contact centers reach prospective contacts. In order to ensure contact the system may further analyze both the list before calling and results of the list as it is calling to know which order is most desirable to ensure highest over all response rates.

In one embodiment, the system may provide an agent with a call and an agent is able to follow a pre-determined script that will be associated with the call. The call may be a preview call, a manual dial call, a predictive call or an inbound call, or any number of other calls. During the call the system is provided the same script as the agent and as the call progresses the agent reads the script and identifies and provides answers to questions and responses in the system that are presented to the agent. While the agent is filling out the script with the agent's response the system may notify call recording software which may tag the recording with key words, events, tags or other meta-data as the call continues. The system is able to automatically transcribe and present sections of the script and the phone call, in real time or post call, to the agent and to supervisors as well as being logged into the system. Key words events, tags or other meta-data may be highlighted or identified in the script and scores or a point system may be assigned based on the script adherence, sentiment of the individual on the phone with the agent, discovered problems and other custom assigned tasks. Calls may be flagged automatically, based on key words events, tags or other meta-data or based on script adherence, sentiment or other data the system discovers and uses, for further key word analysis for further review, immediately if needed or for future need.

In another embodiment agent pacing is analyzed. Instead of using simulations or complex predictions the system may simply look at what happened over the interval, for example, the last 10 minutes, and adjust by a delta each iteration to tell how many calls the system should be sending per agent. This is contrary to current alternative predictive dialing systems which typically employ some type of simulation or predictive algorithm which under performs which is of the premise that each of the next few calls will likely be similar to the last few without making any changes or very minor changes.

In another embodiment agent triggers are utilized as an efficiency tool to optimize the calls made per agent and which may allow call centers to self-manage. Using the system a client (or call center owner, or supervisor of a call center) may specify behaviors or states and based on time in a given state or behavior take automated action (such as send a message to the agent, or move them to a new call, etc.). These actions are then reported on and can be used to measure agent's productivity in some instances. This may be executed by a manager (which may be the client or the manager on behalf of a client) setting up specific parameters and behaviors for agents to comply with; however, this may also be based strictly on agent activity. The system is set-up to monitor and watch for these behaviors. If certain behaviors are flagged or a given state of activities the system may take automatic action or a manager may take manual action, within the system to send a message to the agent identifying the behavior or state, to log the agent out, to send the agent to a new activity, to move the agent to a new state, to remove the agent from the call, etc.

It is to be understood that the system and methods provided herein can be utilized as a software program within a computer-readable medium, may be hardware based, may be based and managed in the cloud or any variation there between. The features of the system and method may be employed in a number of current systems and in a number of different ways that may be automatic or customizable. This description may set forth certain embodiments but each may be mixed and matched and each is clearly contemplated herein.

### BRIEF DESCRIPTION OF THE DRAWINGS

FIG. 1 illustrates an embodiment of a system for predictive and real time dialing analysis;

FIG. 2 illustrates a block diagram of the system of FIG. 1 with review of agents by managers;

FIG. 3 illustrates a flow chart diagram of one method of utilizing the system of FIG. 1 for sequential and campaign parameter dialing;

FIG. 4 illustrates a flow chart diagram of one method of utilizing the system of FIG. 1 utilizing agent triggers to perform functions in a computer readable medium;

FIG. 5 illustrates a flow chart diagram of one method of utilizing the system of FIG. 1 for call quality control; and

FIG. 6 illustrates a flow chart diagram of one method of utilizing the system of FIG. 1 for agent pacing.

### DETAILED DESCRIPTION

Referring in general to the accompanying drawings, various embodiments of the present method and system are illustrated to show a system and methods for predictive and real time dialing analysis. The analysis may then allow the predictive dialing to be more accurate and on point based on the actual real time data collected during each successive call. The figures illustrate common elements. It should be understood that the FIGS. presented are not meant to be illustrative of actual views of any particular portion of the actual device structure, but are merely schematic representations which are employed to more clearly and fully depict embodiments of the system.

The following provides a more detailed description of ways to implement the present system and method and various representative embodiments thereof. The following description sets forth the proper system and method for call centers and predictive dialing. In various embodiments, methods, devices, systems, and computer-readable media for controlling one or more call systems via a computer feedback program are disclosed. As an example, a predictive call may, in response to the previous calls, may be made based on the agent's feedback provided to the system, or computer feedback program.

In this description, some drawings may illustrate signals as a single signal for clarity of presentation and description. It will be understood by a person of ordinary skill in the art that the signal may represent a bus of signals, wherein the bus may have a variety of bit widths and the present description may be implemented on any number of data signals including a single data signal.

A predictive dialing system may include a number of methods for monitoring and providing feedback. A user may set up the system to provide the responses requested to provide optimum feedback and predictive dialing for future calls. Multiple variations on the theme of predictive dialing will be disclosed further herein and it will be appreciated, by one of ordinary skill in the art, that functional changes may be implemented in each embodiment.

In each instance there are basic call flow patterns that the system can recognize and is disclosed further herein. Each flow pattern will be discussed briefly and then more detail will follow.

A basic outbound call flow may begin with a list uploaded to a designated website. A client schedules a call program with a list that may include rules for controlling that call flow which may include pacing, delivery, re-calls, messages, compliance, etc. These rules and parameters are executed against each call that is made by an agent. The system may execute the call and the call is then reported on through the system. The list executing feedback from agents, mangers, or call results can impact how future contacts maybe made on the list.

A second iteration or embodiment may be a basic manual call flow. The flow may include an agent logging in. The agent may then enter numbers to dial while those numbers entered may be compared are “scrubbed” against the client's compliance rules and if the number passes compliance then the call may be executed. If the number does not pass compliance then the call is not executed and a message may present itself on the agent's screen (of a laptop) or user interface and the number and call or lack of call is reported on.

An alternate method may be a basic manually approved call flow. In this instance a list may be uploaded to a website. A client schedules a call program with a list that may include rules for controlling that call flow which may include pacing, delivery, re-calls, messages, compliance, etc. These rules and parameters are executed against each call that is made by an agent. An agent may then login to the system and once logged in the agent receive call records. The agent may review the call records and if the call was allowed the agent marks, or “clicks”, or otherwise signals, that the call was allowed. The calls may then be scrubbed for compliance once again and the call may be executed. Once the call is executed the evidence of the call and the information from the call is reported on in the system.

Yet another method may be the basic preview call flow. This method may include a list to be uploaded to a website. A client schedules a call program with a list that may include rules for controlling that call flow which may include pacing, delivery, re-calls, messages, compliance, etc. The compliance rules are executed against each call. The system executes the call and once the call is made the call is scrubbed for compliance at least a second time. The call is reported on and entered into the system based on the feedback from the call and the success or failure of the call.

Another method of call flow may be the basic inbound call flow which may include a call coming into the system. Call is sent to a target, or agent, based on the inbound number that was called. The call may be sent to target also based on the number of calls, the expertise of the call or a number of other factors. The call is then received by an agent, or the call is “executed” with an agent on the call engine based on the parameters and factors provided to the system by the client.

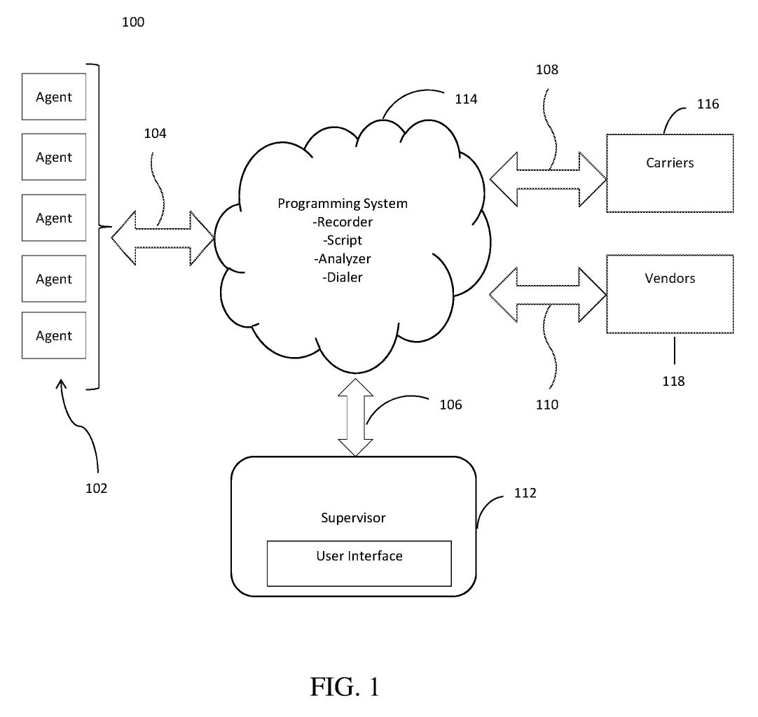

Referring to FIG. 1, a system 100 is set up utilizing agents 102 which may be in a call center. The agents 102 may utilize a computer and a phone to make calls to current or prospective customers. The computers may have access to a cloud 104 via a connection 106. The cloud 104 may comprise programming system 108 which is outlined in greater detail herein and in the appended drawings. The programming system 108 may include a recorder to record calls; a script for an agent to follow; an analyzer to analyze the calls, including the language used the tone used and key words; a compliance engine, and a dialer which may predictively dial for the agent.

The programming system 108 in the cloud 104 may communicate with a supervisor 109 via a first pathway 110. The cloud 104 may also communicate information to carriers 116 via a second pathway 112 and/or vendors 118 via a third pathway 114. The supervisor 109 may interact with a user interface 120 which may be on a computer, a tablet, a smart phone or other suitable medium. The supervisor 109 may be able to review, analyze and manipulate any of the information provided through the programming system 108.

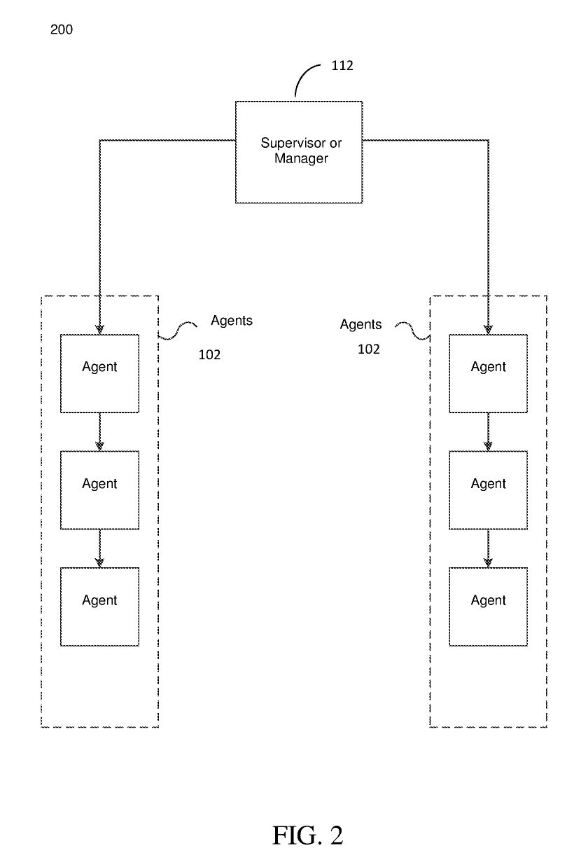

Referring to FIG. 2, the supervisor 109 may have access to multiple agents 102 in multiple call centers or simply multiple agents 102 in a single call center. However, each agent may be providing work to a single client or multiple clients and the supervisor may monitor multiple agents who are servicing multiple clients. The programming system 104 may allow ease in changing from one client to another by allowing the system to provide the proper script, recording and analysis for the specific client required. Each client may manipulate pieces of the programming system 104 to tailor to that client's needs, allowing the agents 102 to make proper calls with proper scripts and proper analysis and proper compliance rules by the programming system 104.

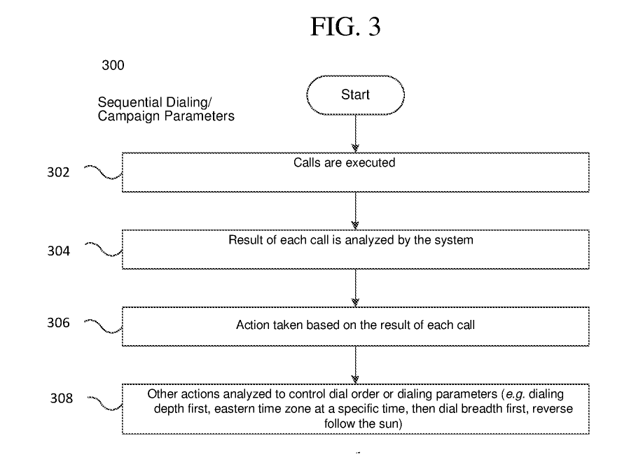

Referring to FIG. 3, one embodiment of a method 300 for providing predictive dialing in the system 108 is contemplated. The method 300 may begin with the system 108 executing a call 302. During the call the conversation between agent and customer is recorded and analyzed 304 by the system. Based on the information received from the call and answers provided by the customer to the agent and the agent filling out questionnaires and the agent clicking on inquiries the system generates during the call, the system takes action 306 by providing real time data of the current call and using that information for the future, including both calls to this contact and for future calls and predictively dialing and providing immediate information to the agent, the supervisors/managers and ultimately carriers and vendors. The actions that may be taken can include call again immediately or mark the record as complete or other action as well including adding meta-data to the system for use in future compliance rules or other campaigns.

The actions 306 taken by the system lead to further actions 308 which may include the system providing depth dialing first and going the direction of the sun or alternatively the system may provide breadth dialing first and reverse follow the sun. Many other call compliance rules or parameters for dialing can be configured including frequency of calls per week or other period of time, types of calls allowed, time of day calls that are allowed to dial, and rules for discovery of the callers physical location. The method 300 of the system may be customized by a client who then sets these parameters and feedback analyses for the agents to follow that the system then performs. An example of dial depth first is perhaps from the hours of 8:00-10:30 (only the eastern time zone) and then from 10:30-12:00 dial depth as well (only eastern, central time zones, central priority) and then from 12:00-2:00 dialing depth as well (first eastern, central, mountain, mountain priority) and then from 2:00-5:00 dialing depth first (all time zones, follow the sun) and then 5:00-9:00 dialing breadth first (reverse follow the sun).

Sequential dialing is a way to program the system 108 with behaviors to automatically recall some numbers on given intervals based on result or result frequency. This can be extended to do the same based on responses for agents 102.

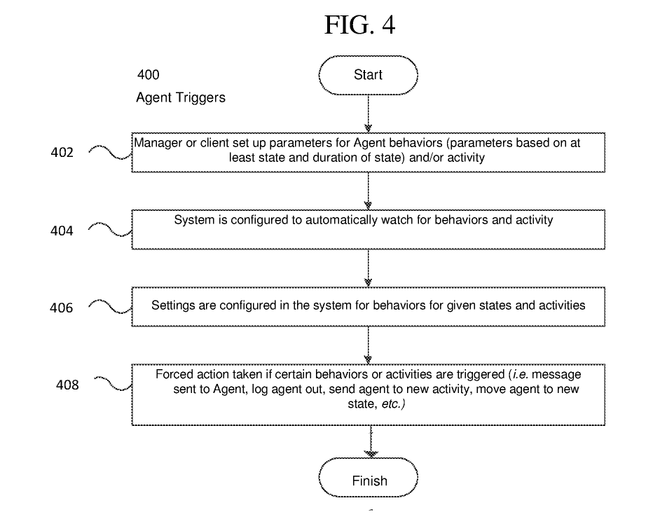

Referring to FIG. 4, another embodiment of a method 400 that may be utilized in the system 108 is contemplated. As with all methods each may be customized. A manager or client may establish parameters 402 for agent behaviors. These parameters may be based on “at least state” or “duration of state” or activity or inactivity of the agent. Agent state is analyzed by the system 108 and reports or information may be immediately generated to a supervisor and the system 108 itself may provide feedback to the agent based on the agent's state.

The system 108 watches behaviors and activities 404 of an agent and may automatically produce information provided to an agent through the system 108. Sensitivity and settings are configured in the system 406 that allow for these notifications or triggers of the agent state flags the system and action is taken 408.

The action 408 may be a forced action if certain behaviors or activities are triggered by the information provided to the system based on the Agents state. Examples of forced action taken by the system include, but are not limited to, messages sent to agent notifying that agent of his/her current state and instructions on how to move out of the current state; log the agent out of the current activity or behavior; immediately transfer or send the agent to a new activity; or move the agent to a new state. Agent Triggers are an efficiency tool which allows call centers to self-manage. These actions are then reported on and can be used to measure agent's productivity in some instances.

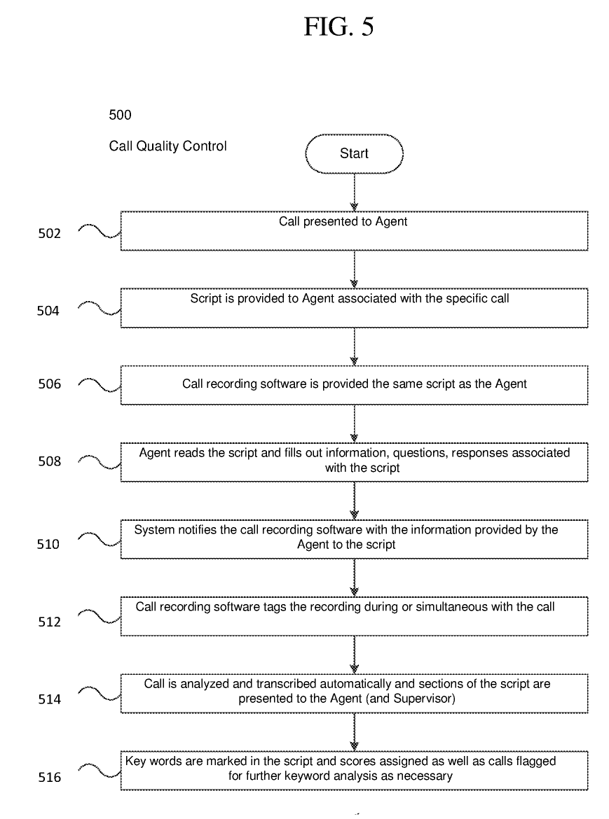

Referring to FIG. 5, another embodiment of a method 500 of the system 108 is contemplated. The system 108 may allow for quality control of the calls agents are making to customers. The method 500 may begin with the system 108 executing a call 502. A script may be provided 504 to the agent 102. The script may be associated with the specific call that may have been drafted or provided by a client. Call recording software may be provided the same script as the agent 506 so that the software may utilize that script to analyze the agent's 102 ability to follow the script.

While the agent 102 is reading the script provided the agent 102 may fill out information, or questions, with the responses associated with the script 508. The questions, information, responses, etc. requested by the system 102 may be provided to the system by the client or from the program itself analyzing the script and what the script is seeking. The system and the system software may provide feedback to the agent based on the software's analysis.

The system 108 may notify 510 the call recording software with the information provided by the agent 102. The agent 102 may respond to those parts of the script that require responses wherein the agent fills out the response within the script itself within the system 108. The recording software may then tag 512 the recording during the call or simultaneously with the agent 102 filling in the responses or the questions. The tagging 512 of the recording allows feedback, or a response, entered into the system 108 by the agent 102 to be flagged with a position in the recording. In other words, while agents 102 listen to calls, allowing the system 108 to automatically flag and tag different segments of the calls based on the portion of the quality questionnaire currently being filled out. Further allow automated systems to automatically flag or tag in the recordings portions that should be listened to by a human (based on either uncertainty or analysis or key words or phrases being discovered). Further presenting to human quality control workers different surveys or questions to fill out based on what the automated systems have discovered.

The call by the agent 102 is recorded and transcribed by the software. The transcription may be presented 514 to the agent 102 and the supervisor 112 automatically either during the call, simultaneous with the call, or after the call is ended. The transcription provided to the supervisor 112 and the agent 102 may include the feedback entered into the system 108 by the agent as well as those sections flagged in the recording such that the supervisor and agent can analyze the responses with feedback entered by the agent and assure that the responses match with feedback entered by the agent. The system 108 may also mark the script 516 and assign scores to the agent for following the script and entering responses provided by the system 108 associated with the script. The more accurate the agent 102 follows the script and enters responses associated with the script the better those scores are for the agent and for the call itself.

Key words may also be marked 516 in the script and the recording and responses of the agent are analyzed against the script to assure the agent is following the script. Calls may be flagged for further keyword analysis if necessary to assure quality control of the agents 102 making the calls for clients.

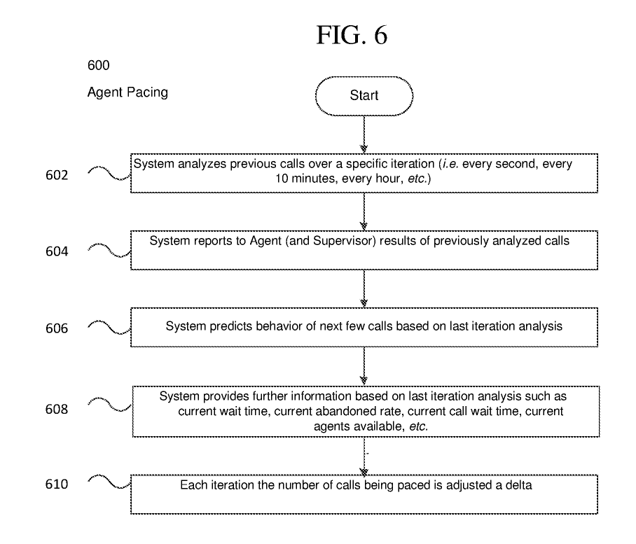

Referring to FIG. 6, another embodiment of a method 600 of the system 108 is contemplated. The system 108 may allow for pacing agents 102 on calls agents 102 are making to customers. The method 600 may begin with the system 108 analyzing 602 previous call over a user specified iteration. The iteration may be every second, every minute, every 10 minutes, every hour, etc. The system 108 may then report 604 to the agent 102 and/or the supervisor 112 the results of the previously analyzed calls. The system 108 may then predict 606 behavior of the next number of calls (i.e. next two calls, next five calls, next 10 calls, etc.). The system 108 may provide further information 608 based on the iteration analysis. The information provided may include current wait times, current abandonment rates, current call wait times, current agents available for calls, etc. Following the iteration analysis the number of calls may be adjusted 610. The delta that agents are paced is continually analyzed and adjusted based on the previous analyses.

The agent pacing is different than most. Instead of using simulations or complex predictions the current embodiment looks at what happened over the previous 10 minutes and adjust by a delta each iteration to provide information on how many calls should be sent per agent 102. Alternatives employ a type of simulation or predictive algorithm which may under-perform in assuming the next few calls will likely be similar to the last few and making minor adjustments each round.

The flow of the agent pacing may be as follows: each iteration (could be as often as each second) and the results of the previous calls are analyzed (the period of time could be any period) based on the results of the analyzed calls informs how the next few calls may behave. Parameters such as current wait time, current abandoned rate, current call wait time and current agents available may also be used to inform future calls. Each iteration the number of calls being paced may be adjusted a small delta (this delta can be informed by the same parameters).

Alternatively, a system may have the ability for the same calling logic to control both SAAS systems and premise based systems. Many times contact centers have hardware and software internally which they use for their calling. Sometimes their agents are not busy and the hardware (which has fixed capacity) is unable to keep the agents busy. The system may be implemented where this the agents work may be automatically shifted to an alternate system (while utilizing the same agents) then customers could receive move efficiency without managing two systems.

A premised based dialer and cloud based dialer are different and the premised based dialing usually will be cheaper to operate on a call by call basis (with a limited capacity). However, the cloud based dialer may choose which system should send each call based on real time capacity updates from the premised based dialer. The premised based dialer may send updates on call results to the cloud. The premised based dialer may send capacity updates. The cloud based dialer responsible for all the campaigns may send calls to either the premised based or the cloud based dialer depending on a variety of factors including the capacity of each dialer the agent 102 availability and the cost of operation.

Although the foregoing description contains many specifics, these should not be construed as limiting the scope of the description or its embodiments or methods or of any of the appended claims, but merely as providing information pertinent to some specific embodiments that may fall within the scopes of the description and the appended claims. Features from different embodiments may be employed in combination. In addition, other embodiments of the description may also be devised which lie within the scopes of the description and the appended claims. The scope of the description is, therefore, indicated and limited only by the appended claims and their legal equivalents. All additions, deletions and modifications to the description, as disclosed herein, that fall within the meaning and scopes of the claims are to be embraced by the claims.

1. A method of optimizing call quality in a system with a transitory computer readable medium, the method comprising:
uploading-accessing a call list from the system;
executing a first call to a first customer;
recording the call with the customer and storing recording data to the system;
tagging a script provided to an agent based on the real-time recording data and agent responses from the customer;
dialing responsively to the customer based on recording data from the first call.

2. (canceled)

3. The method of claim 2 comprising, signailng the system with the recording data comprising:
recorded conversation of the call; and
answers entered into the system provided by the agent.

4. The method of claim 3 comprising, tagging the call simultaneously with the customer answering of the questions by the agent and the agent entering the answers into the system.

5. The method of claim 3 comprising, analyzing the information provided by the recording and the information entered by the agent into the system and providing a real-time transcription to the agent.

6. The method of claim 5 comprising, providing a transcription to a supervisor.

7. The method of claim 1 comprising, marking and using the recording data, and agent responses from the customer, to responsively dial a second customer.

8. The method of claim 1 comprising, assigning scores to agents based on script adherence and questions answered.

9. A system for monitoring call quality comprising:
a non-transitory computer readable medium comprising
a cloud based software configured to receive a call list and parameters for making calls provided by a first client, the cloud based software also configured to provide:
real time data analysis and feedback of a current call, the real time data including at least one of meta-data, call back frequency, record is complete, compliance to a script, alteration of a script, providing a new script, agent availability, agent productivity, agent pacing, or capacity updates;
a script provided by a client for an agent to follow when calling customer;
an interface with the software to allow agent to enter data based on customer responses;
call recording software configured to record a call and provide real-time data of the recorded call; and
responsively dialing a customer based on the real time data analysis from the agent entered data based on customer responses and the recorded call.

10. The system of claim 9 comprising, a questionnaire for the agent to respond in association with the script.

11. The system of claim 10 comprising, analytical software configured to analyze the script against the questionnaire.

12. The system of claim 9 comprising, transcribing software configured to transcribe a call between the agent and the customer.

13. The system of claim 12 comprising, tagging software configured to tag the transcribed call based on key words.

14. The system of claim 13, wherein the tagging software is configured to tag the script and the transcription simultaneous with the call.

15. The system of claim 9 comprising, a scoring system configured to score the agents based on script adherence.
